(19) United States
(12) Patent Application Publication
(10) Pub. No.: US 2004/0267617 A1
(43) Pub. Date: Dec. 30, 2004

(54) Method and system for charging vehicle advertisement rate

(75) Inventor: Kazuhiro Yanase, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/866,808

(22) Filed: Jun. 15, 2004

(30) Foreign Application Priority Data
Jun. 16, 2003 (JP) 2003 - 170844

(51) Int. Cl. G06F 17/60

(52) U.S. Cl. 705/14

(57) ABSTRACT

Provided are a method and a system for charging an appropriate vehicle advertisement rate in a vehicle advertisement service having an advertisement on the external body part of the vehicle. In an advertising vehicle, vehicle sensors for detecting the traveling state such as the traveling speed and the traveling position, and an on-vehicle terminal for importing the information detected by the sensors as the traveling state information are mounted. The traveling state information is imported to a vehicle-state collecting server of a prove information center from the on-vehicle terminal through a network. An advertisement rate calculating server calculates the advertisement rate from the traveling state information and data of an advertisement rate system stored beforehand in which unit rates per traveling distance, changing ratio of the unit rates according to the traveled unit area and the like are collected. Then, the information on the advertisement rate and the traveling state information are transmitted to the advertiser terminal.

### BACKGROUND OF THE INVENTION

1. Field of the Invention

The present invention relates to a method and a system for charging an appropriate vehicle advertisement rate in a vehicle advertisement service in which an advertisement is placed on the external body part of a vehicle.

2. Description of the Related Art

As a service for advertising various products and services, other than services for placing advertisements inside buildings or on the walls, there is a vehicle-advertisement service using public transportation such as buses or trains, which travel regular routes, through having an advertisement on the external body parts.

This type of service can expect an efficient propaganda effect targeting such as pedestrians and passengers on the other vehicles that use the roads where the vehicles with the advertisement travel through. It is considered that, in addition to using the vehicles traveling through the regular routes, an excellent propaganda effect can be expected by placing advertisements on the external body parts of vehicles such as taxis and business vehicles which travel irregular routes.

However, there are not many cases of using such vehicles with no specific routes to be traveled through as the advertising vehicles. One of the reasons for this is that it is hard to set the advertisement rate since the route of the vehicle is unknown until it actually has traveled. That is, if the advertisement rate is set beforehand, it is hard for users of the advertisement service to know where the advertising vehicle is to travel and to judge whether or not a satisfactory service can be obtained as a result. Thus it is hard to use this type of advertising service.

For this, for example, Japanese Unexamined Patent Publication No. 2002-259841, Japanese Unexamined Patent Publication No. 2003-044761 and Japanese Unexamined Patent Publication NO. 2003-140588 disclose a method for calculating an advertisement rate of an advertisement using a vehicle traveling through an irregular route based on information on an actual traveling state of the advertising vehicle.

As described above, by calculating the advertisement rate based on the information on the actual traveling state of the advertising vehicle, it becomes possible to set a relatively rational advertisement rate.

However, in the above-described related art, the users of the advertising service cannot check where the advertising vehicle actually has traveled. Thus, it is hard to judge whether or not the advertisement rate to be charged is appropriate and to evaluate the advertising effect.

### SUMMARY OF THE INVENTION

An object of the present invention is to overcome the foregoing shortcomings. It is to provide a method and system for charging vehicle advertisement rate in which an appropriate advertisement rate can be calculated to be charged and advertisers can verify the appropriateness of the advertisement rate in a vehicle advertising service in which an advertisement is placed on its external body part.

In order to achieve the foregoing object, a vehicle advertisement rate charging method according to the present invention is a method for charging the vehicle advertisement rate when using an advertising vehicle having an advertisement placed on its external body, comprising the steps of: detecting a traveling state of the advertising vehicle and importing it as traveling state information to an on-vehicle terminal loaded on the advertising vehicle by a vehicle sensor loaded on the advertising vehicle; managing the traveling state information of each advertising vehicle and importing the traveling state information in the on-vehicle terminal to a server provided in an information center performing calculating processing of vehicle advertisement rate; calculating the total amount of the vehicle advertisement rate based on the traveling state information and data of an advertisement rate system in which each unit rate of the vehicle advertisement rate determined by the traveling state information is collected, which is stored beforehand in the server provided in the information center; and transmitting the traveling state information used for calculating the vehicle advertisement rate to an advertiser terminal through connecting to the advertiser terminal held by an advertiser through a network by the server provided in the information center.

With the method for charging the vehicle advertisement rate, it is possible to calculate the vehicle advertisement rate based on the information on the actual traveling state of the advertising vehicle such as the traveling position, traveling distance, traveling hour, traveling speed and stopping time. Further, by transmitting the traveling state information to the advertiser terminal, the advertiser can recognize the traveling state information used for calculating the vehicle advertisement rate.

More specifically, calculation of the vehicle advertisement rate according to the present invention is achieved by calculating the traveling distance of the advertising vehicle as the traveling state information using a GPS (Global Positioning System) or a speed pulse generator as a vehicle sensor, and then multiplying the unit rate of the vehicle advertisement rate per traveling distance which is stored as the data of an advertisement rate system by the traveling distance. Further, the unit rate may vary according to the unit area and the traveling hour of the advertising vehicle so that the vehicle advertisement rate can be made more rational.

Importing of the traveling state information to a server provided in an information center may be achieved by, in addition to using a network, storing the information in a recording medium once and then mounting the recording medium onto the server provided in the information center. In the former method, the traveling state information can be effectively imported and, in the latter method, fee for using the network can be decreased.

The vehicle advertisement rate may be achieved by notifying it to the advertiser, however, an electronic settlement may also be used for charging. Thereby, it enables to improve the convenience.

A system for charging vehicle advertisement rate according to the present invention comprises: an on-vehicle terminal provided on an advertising vehicle for importing detection signals which detected traveling state of the advertising vehicle having an advertisement on its external body part, as the traveling state information; and a server provided in an information center which manages the traveling state information of each advertising vehicle and performs a calculating processing of advertisement rate. In the server, data of an advertisement rate system, each unit rate of the vehicle advertisement rate determined by the traveling state is collected therein, is stored; the traveling state information in the on-vehicle terminal is imported; and the total amount of the vehicle advertisement rate is calculated based on the traveling state information and the data of the advertisement rate system. The server provided in the information center can be connected to an advertiser terminal used by an advertiser through a network and the traveling state information can be transmitted to the advertiser terminal.

### BRIEF DESCRIPTION OF THE DRAWINGS

FIG. 1 is a block diagram showing a vehicle advertisement charging system according to a first embodiment of the present invention;

FIG. 2 is a flow chart of a vehicle advertisement charging method according to the first embodiment;

FIG. 3 is a conceptual figure showing an example of information accumulated in a vehicle-state collecting server used in the vehicle advertisement charging method shown in FIG. 2;

FIG. 4 is a figure showing an example of the result obtained by calculating the advertisement rate by the vehicle advertisement charging method shown in FIG. 2;

FIG. 5 is a flow chart of a vehicle advertisement charging method according to a second embodiment;

FIG. 6 is a conceptual figure showing an example of information accumulated in a vehicle-state collecting server used in the vehicle advertisement charging method shown in FIG. 5;

FIG. 7 is a figure showing an example of the result obtained by calculating the advertisement rate by the vehicle advertisement charging method shown in FIG. 5;

FIG. 8 is a block diagram showing a vehicle advertisement charging system according to a third embodiment;

FIG. 9 is a flow chart of the vehicle advertisement charging method according to the third embodiment; and

FIG. 10 is a block diagram showing a vehicle advertisement charging system according to a fourth embodiment.

### DETAILED DESCRIPTION OF THE PREFERRED EMBODIMENTS

In the followings, embodiments of the present invention will be described by referring to accompanying drawings.

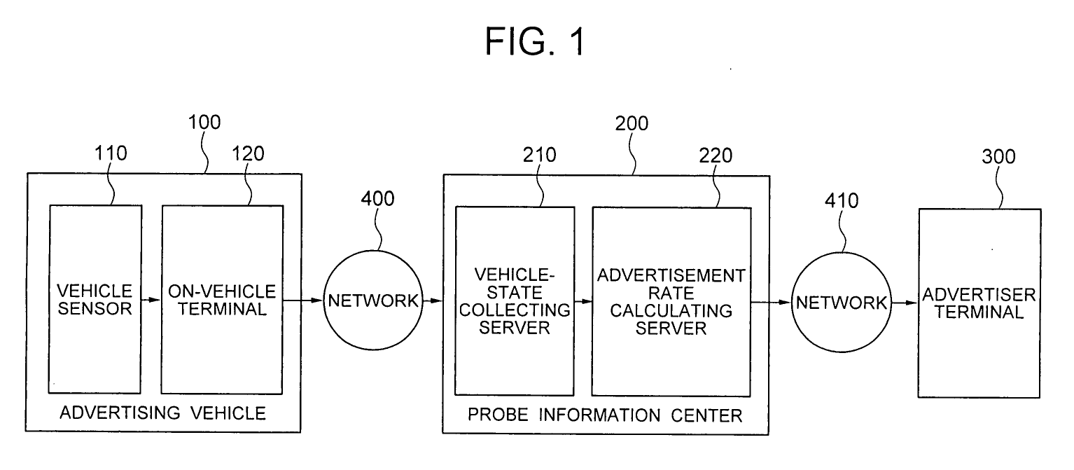

FIG. 1 shows a block diagram of a vehicle advertisement charging system according to a first embodiment. As shown in FIG. 1, an advertising vehicle 100 having an advertisement requested by an advertiser being illustrated on its external body part by painting or lapping comprises various vehicle sensors 110 for detecting the traveling state of the vehicle 100, and an on-vehicle terminal 120 to which the vehicle sensors 110 are connected. As the vehicle sensors 110, various types can be used. In the embodiment, a GPS and a speed pulse generator are used as the vehicle sensors 110. The on-vehicle terminal 120 is an information processing terminal having a function of connecting to a network 400 such as a portable telephone network. It grasps the traveling state of the advertising vehicle 100 including the whereabouts, speed, distance, hour and calculates the necessary traveling state information based thereon.

The on-vehicle terminal 120 can be connected to a probe information center 200 through the network 400. Here, the probe information means, on the assumption that the vehicle is the probe, various types of information regarding the roads and the advertising vehicle 100 itself including the traveling state information which is detected by the various vehicle sensors 110 loaded on the vehicle and then calculated by the on-vehicle terminal 120.

The probe information center 200 accumulates the probe information imported from the on-vehicle terminal 120 of the advertising vehicle 100 and calculates the advertisement rate based on the probe information. It may be formed with information processing devices such as a work station and a server. In an example shown in FIG. 1, in the probe information center 200, provided are a vehicle-state collecting server 210 for accumulating/managing the probe information and an advertisement rate calculating server 220 for calculating the advertisement rate based on the probe information stored therein. The probe information center 200 can be connected through a network 410 to an advertiser terminal 300 used by the advertiser, which is an information processing device such as a personal computer.

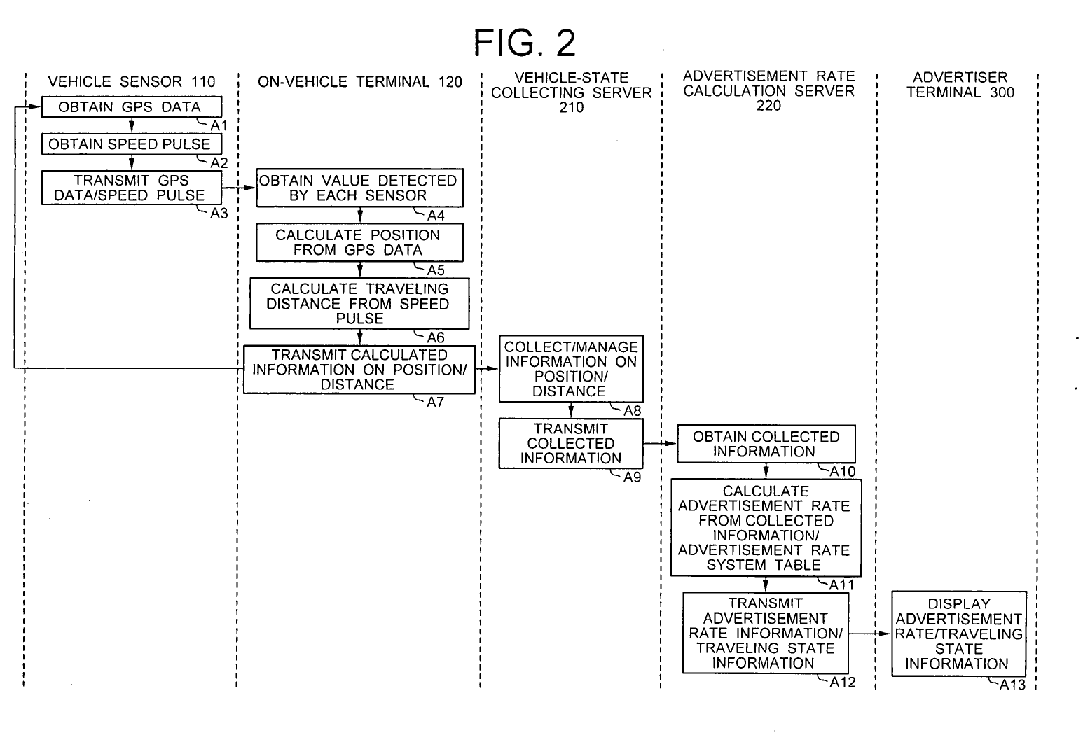

Next, by referring to FIG. 2, a method for charging a vehicle advertisement rate according to the embodiment will be described. FIG. 2 is a flow chart of the method for charging the vehicle advertisement, in which each processing is illustrated by each apparatus which executes the processing.

First, GPS data is obtained by the vehicle sensors 110 (A1) and the speed pulse is obtained as well (A2). The obtained GPS data and the speed pulse are transmitted to the on-vehicle terminal 120 (A3).

The on-vehicle terminal 120 obtains the GPS data and the speed pulse transmitted from the vehicle sensors 110 (A4) Positional information in latitude and longitude is calculated from the GPS data (A5) and the traveling distance is calculated from the speed pulse (A6). Then, the calculated information on the traveling position and the traveling distance is transmitted to the probe information center 200 through the network 400 (A7).

The processing from A1 to A7 is repeatedly executed for transmitting the changes in the traveling position and the traveling distance of the advertising vehicle 100 to the probe information center 200. For example, it is repeated in a constant cycle while the traveling position and the traveling distance are changing.

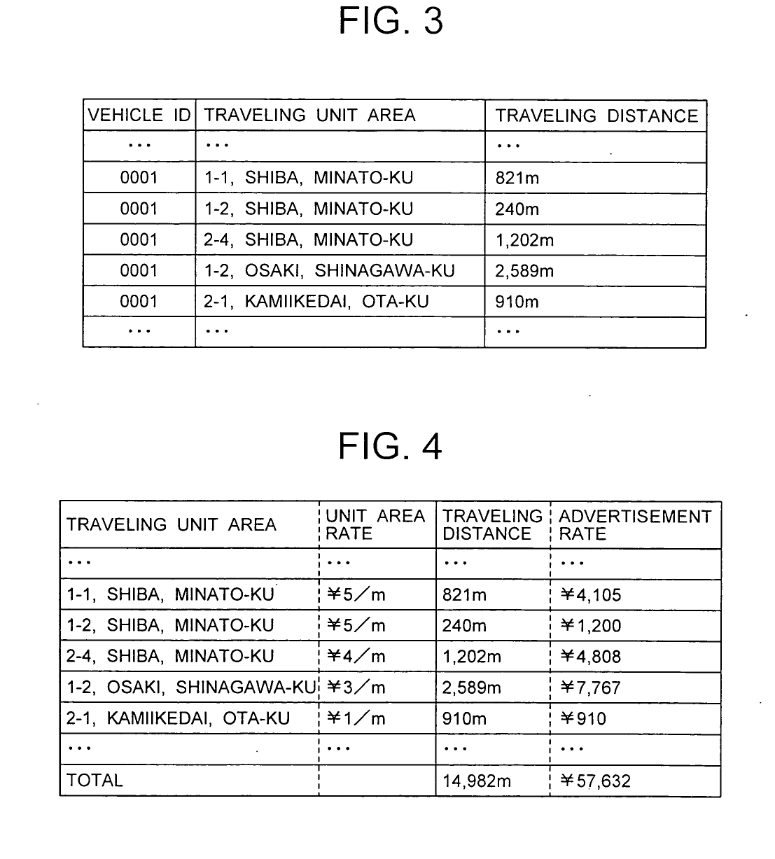

The probe information center 200 obtains the information on the traveling position and the traveling distance of the advertising vehicle 100 and manages the information by collecting it in the vehicle-state collecting server 210 (A8). FIG. 3 shows a conceptual figure of an example of the collected information. In other words, the obtained information accumulated by each advertising vehicle 100 is accumulated in the state where the information is added by each unit area where the advertising vehicle traveled through. The accumulated information is transmitted to the advertisement rate calculating server 220 when necessary (A9).

The advertisement rate calculating server 220 obtains the information collected as described above regarding the traveling position and the traveling distance from the vehicle-state collecting server 210 (A10) and calculates the advertisement rate (A11). FIG. 4 shows an example of the calculation result of the advertisement rate. In the vehicle-state collecting server 210, the unit area rate which is the advertisement rate per unit traveling distance by each unit area is stored. The unit area rate can be set beforehand as an advertisement rate system by going through an adjustment and the like between with the advertiser. For example, the rate is set relatively high for the unit areas where there are relatively a large number of pedestrians and traffics and relatively low for the unit areas where there are relatively a small number of pedestrians and traffics. The advertisement rates by each unit area and the advertisement rate totaling all the unit areas are calculated from the unit area rate of the advertisement rate system and the collected traveling distance by each unit area as described above.

The information on the calculated advertisement rate and the traveling state information including the traveling position and the traveling distance of each advertising vehicle used for the calculation are transmitted, when necessary, to the advertiser terminal 300, for example, in the end of a month or after the expiration of the contracted advertising term for claiming the advertisement rate to the advertiser (A12). In the advertiser terminal 300, the obtained advertisement rate and the traveling state information can be displayed so that the advertiser can check the advertisement rate and the traveling state information (A13). In the figure, it is illustrated to transmit the traveling state information from the advertisement rate calculating server 220, however, it may be transmitted from the traveling-state collecting server 210. According to the above-described embodiment, the vehicle advertisement rate can be appropriately set according to the actual traveling state of the advertising vehicle 100. The advertiser can judge whether or not the advertisement rate is appropriate by checking the rate system beforehand. Also, the advertiser can check whether or not the claimed advertisement rate is appropriate by referring to the traveling state information and evaluate whether or not a satisfactory advertising effect can be expected. Therefore, it becomes easier for the advertisers to use the vehicle advertisement using the vehicles whose traveling routes are unknown.

In the embodiment, the advertisement rate displayed in the advertiser terminal 300 may include not only the total amount to be claimed but also the rate by each unit area or the rate by each vehicle according to a request from the advertiser. Also, the traveling state information displayed in the advertiser terminal 300 can be displayed in the above-described collected form in which the traveling position and the traveling distance of each advertising vehicle are collected for calculating the advertisement rate. Desired information may be displayed at a desired timing when the advertiser makes an access to the probe information center 200 through the network 410. For example, it is possible to display information in various forms such as the advertisement rate and the traveling state information totaled in a desired period of time, and the traveling state information of a specific advertising vehicle, the traveling state information in which information on specific types of advertising vehicles are totaled. Thereby, it improves the convenience for the advertiser to evaluate the appropriateness of the advertisement rate and the advertising effect. As a result, it improves the credibility of the advertisement rate for the advertiser.

Further, in the embodiment, the method for calculating the traveling distance based on the speed pulse is described. However, the traveling distance may be calculated based on the GPS data. The former method has an advantage that it can calculate the traveling distance relatively easily and with high reliability. On the other hand, the latter method has an advantage that it is unnecessary to connect the signals of the speed pulse to the on-vehicle terminal 120 so that the connection and the device structure become simple.

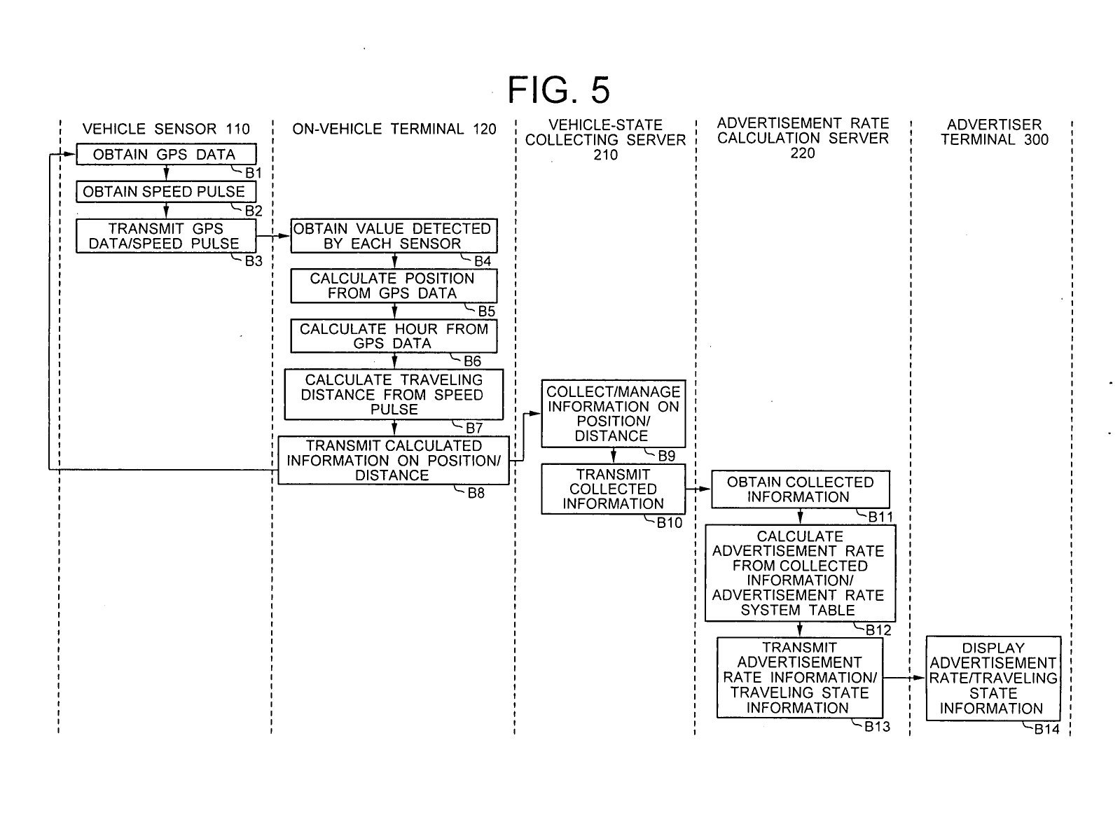

Next, a second embodiment of the present invention will be described by referring to FIG. 5. FIG. 5 is a flow chart of a method for charging vehicle advertisement rate according to the embodiment. It differs from the first embodiment in respect that it obtains the hour data from the GPS data and collects/manages the information of the traveling hour along with the information on the traveling position and the traveling distance for calculating the advertisement rate. As the system for charging the vehicle advertisement rate, the same system as the one according to the first embodiment can be used, so that an illustration and the detailed description will be omitted.

In the method for charging the advertisement rate according to the embodiment, first, the GPS data is obtained by the vehicle sensors 110 (B1) and the speed pulse is obtained as well (B2). The obtained GPS data and the speed pulse are transmitted to the on-vehicle terminal 120 (B3).

The on-vehicle terminal 120 obtains the GPS data and the speed pulse transmitted from the vehicle sensors 110 (B4). The positional information in latitude and longitude is calculated from the GPS data (B5) and the hour is also calculated (B6). The information on “the hour” may contain the date and the day of the week. From the speed pulse, the traveling distance is calculated (B7). Subsequently, the information on the calculated traveling position, traveling hour and traveling distance is transmitted to the probe information center 200 through the network 400 (B8).

The processing from B1 to B8 is repeatedly executed for transmitting the changes in the traveling position, the traveling distance and the traveling hour of the advertising vehicle 100 to the probe information center 200. For example, it is repeated in a constant cycle while the traveling position and the traveling distance are changing.

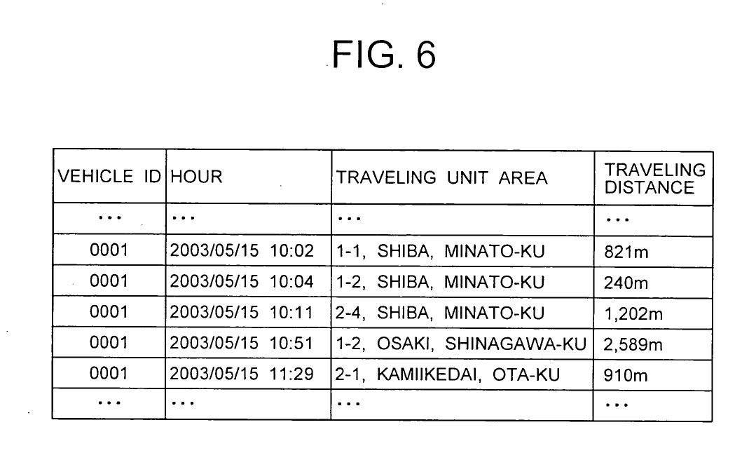

The probe information center 200 obtains the information on the traveling position, the traveling distance and the traveling hour of the advertising vehicle 100 and manages the information by collecting it in the vehicle-state collecting server 210 (B9). FIG. 6 shows a conceptual figure of an example of the collected information. In other words, the obtained information accumulated by each advertising vehicle 100 is accumulated in the state where the information is added by each unit area where the advertising vehicle traveled through, and the traveling hour is stored along therewith. The accumulated information is transmitted to the advertisement rate calculating server 220 when necessary (B10).

The advertisement rate calculating server 220 obtains the information collected as described above regarding the traveling position, the traveling distance and the traveling hour from the vehicle-state collecting server 210 (B11) and calculates the advertisement rate (B12).

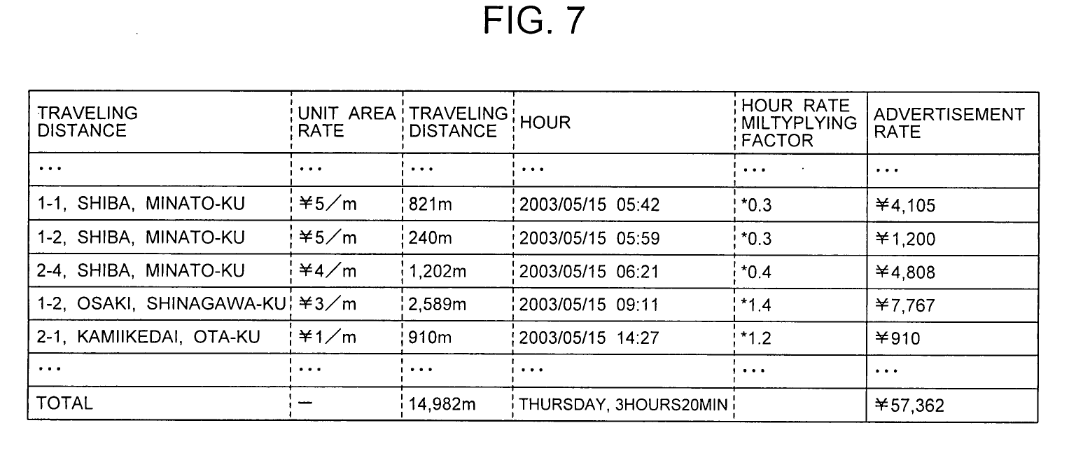

FIG. 7 shows an example of the calculation result of the advertisement rate. In the vehicle-state collecting server 210 according to the embodiment, in addition to the unit rate by each unit area, the hour rate multiplying factors set by each time zone are stored. In other words, the actual unit rate by each unit area is obtained by multiplying the unit area rate by the hour rate multiplying factor. The unit area rate and the hour rate multiplying factor can be set beforehand as the advertisement rate system by going through an adjustment and the like with the advertiser. The advertisement rates by each unit area and the advertisement rate totaling all the unit areas are calculated from the unit area rate and the hour rate multiplying factor in the advertisement rate system and the collected traveling distance and the traveling hour by each unit area as described above.

The information on the calculated advertisement rate and the traveling state information including the traveling position, the traveling distance and the traveling hour of each advertising vehicle used for the calculation are transmitted, when necessary, to the advertiser terminal 300, for example, in the end of a month or after the expiration of the contracted advertising term for claiming the advertisement rate to the advertiser (B13). In the advertiser terminal 300, the obtained advertisement rate and the traveling state information can be displayed so that the advertiser can check the advertisement rate and the traveling state information (B14).

As described above, with the embodiment, it is possible to charge the advertisement rate by taking account of the traveling hour in addition to the information on the traveling position and the traveling distance. Therefore, it is possible to make the advertisement rate further appropriate by setting the advertisement rate high for the time periods when there is relatively a high chances of the advertising vehicle 100 being noticed such as during the daytimes or on holidays with relatively many pedestrians and traffics, and setting it low for the time periods when there is relatively a low chance to be noticed such as midnights or early morning.

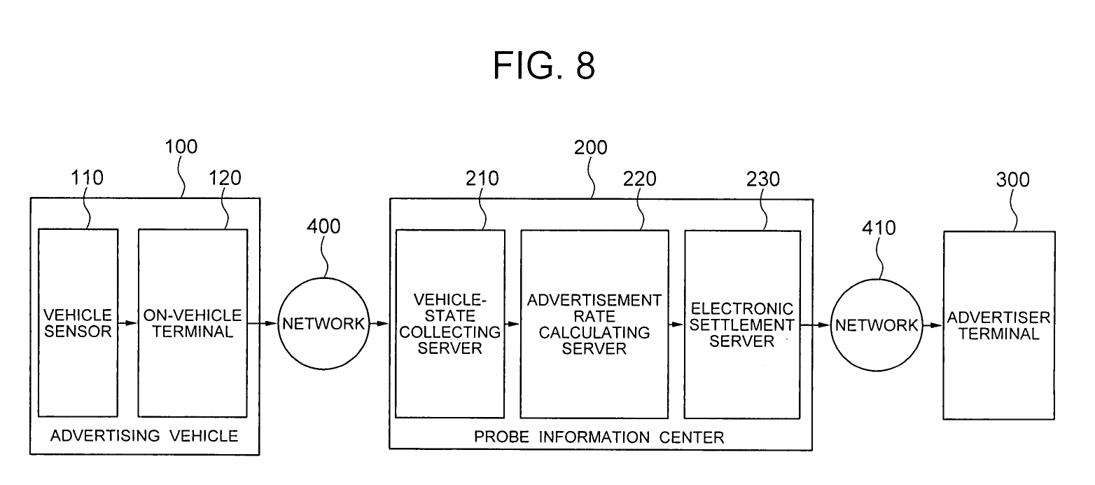

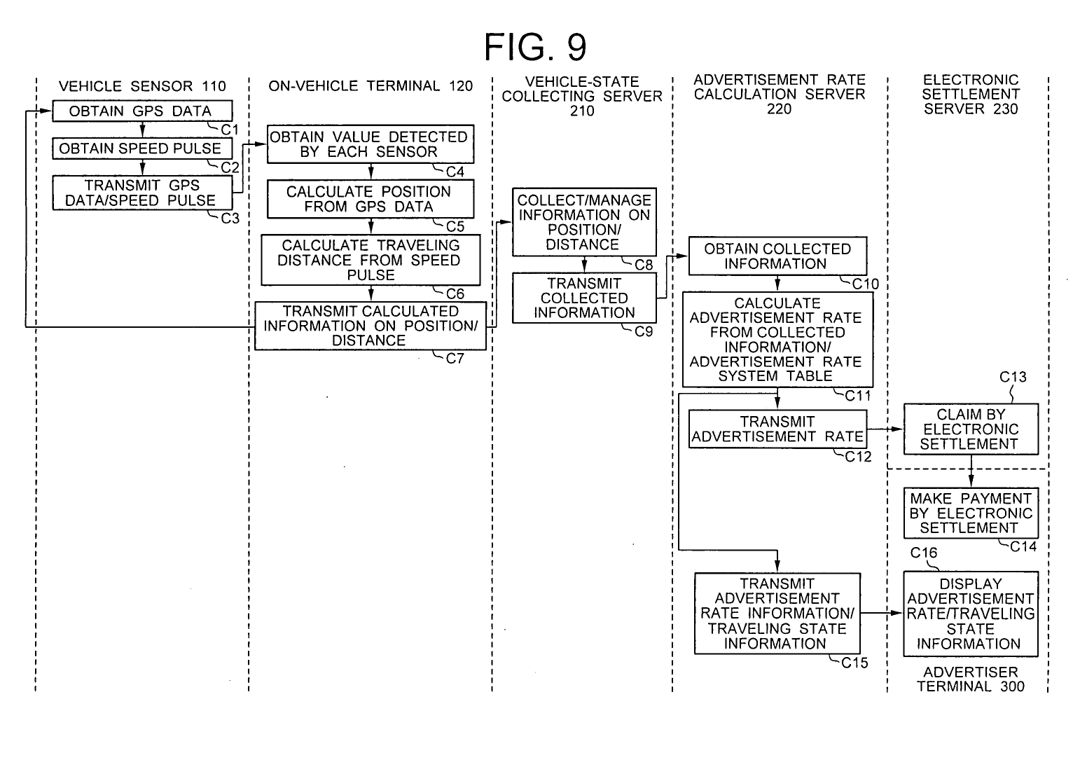

Next, a third embodiment of the present invention will be described by referring to FIG. 8 and FIG. 9. FIG. 8 is a block diagram of the system for charging the vehicle advertisement rate according to the embodiment and FIG. 9 is a flow chart of the method for charging the vehicle advertisement rate according to the embodiment. In FIG. 8, the same numeral codes as the ones used in the first embodiment are used for the identical parts and the detailed description will be omitted.

As shown in FIG. 8, in the embodiment, an electronic settlement server 230 for charging the advertisement rate from the advertiser terminal 300 by the electronic settlement is provided in the probe information center 200.

Next, the method for charging the vehicle advertisement rate according to the embodiment will be described by referring to FIG. 9.

First, the GPS data is obtained by the vehicle sensors 110 (C1) and the speed pulse is obtained as well (C2). Then, the obtained GPS data and the speed pulse are transmitted to the on-vehicle terminal 120 (C3).

The on-vehicle terminal 120 obtains the GPS data and the speed pulse transmitted from the vehicle sensors 110 (C4). Positional information in latitude and longitude is calculated from the GPS data (C5) and the traveling distance is calculated from the speed pulse (C6). Then, the calculated information on the traveling position and the distance is transmitted to the probe information center 200 through the network 400 (C7).

The processing from C1 to C7 is repeatedly executed for transmitting the changes in the traveling position and the traveling distance of the advertising vehicle 100 to the probe information center 200. For example, it is repeated in a constant cycle while the traveling position and the traveling distance are changing.

The probe information center 200 obtains the information on the traveling position and the traveling distance of the advertising vehicle 100 and manages the information by collecting it in the vehicle-state collecting server 210 (C8). The information accumulated as described is transmitted to the advertisement rate calculating server 220 when necessary (C9).

The advertisement rate calculating server 220 obtains the information collected as described above regarding the traveling position and the traveling distance from the vehicle-state collecting server 210 (C10) and calculates the advertisement rate based on the accumulated information and the data of the advertisement rate system (C11). The calculated advertisement rate is transmitted to the electronic settlement server 230 (C12).

The electronic settlement server 230 claims the advertisement rate to the advertiser by claiming it to the advertiser terminal 300 at the end of a month or after completing the contracted advertising term (C13). The advertiser terminal 300 displays the charged advertisement rate to notify the advertiser and performs processing for making a payment through the electronic settlement (C14).

Apart from the electronic settlement, information on the calculated advertisement rate and the traveling state information used for the calculation including the traveling position and the traveling distance of each advertising vehicle is transmitted to the advertiser terminal 300 (C15) and the transmitted information is displayed in the advertiser terminal 300 (C16).

As described above, in the embodiment, the advertiser terminal 300 is also used for the electronic settlement. Thus, it enables to improve the convenience.

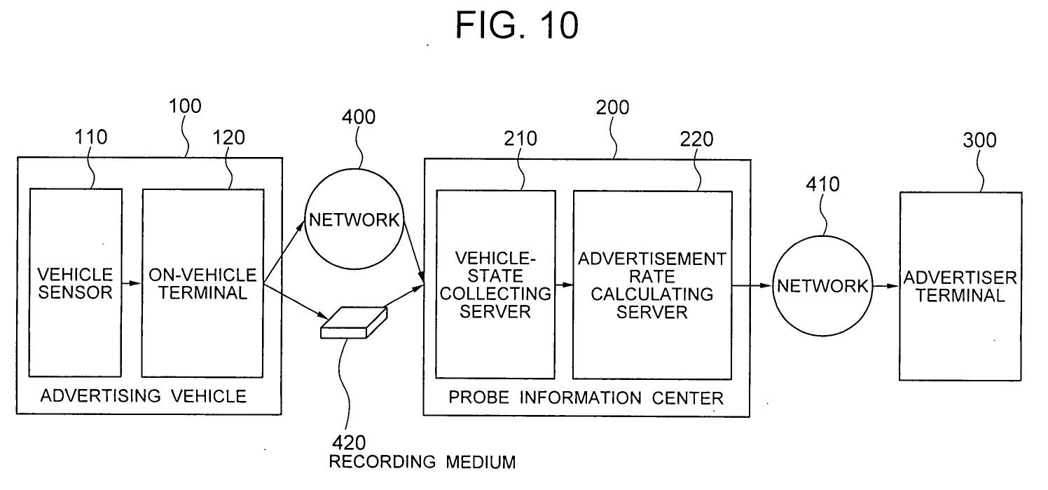

Next, a fourth embodiment of the present invention will be described by referring to FIG. 10. FIG. 10 is a block diagram of the system for charging the vehicle advertisement rate according to the embodiment. In FIG. 10, the same numeral codes as the ones used in the first embodiment are used for the identical parts and the detailed description will be omitted.

In the embodiment, as a method for transmitting the obtained information on the traveling position and the traveling distance from the on-vehicle terminal 120 to the probe information center 200, in addition to the method using the network 400, it is possible to employ a method using a recording medium 420 such as a PC card, a compact flash, an SD card, and a memory stick. In other words, the recording medium 420 is mounted onto the on-vehicle terminal 120 when the advertising vehicle 100 is traveling and the obtained information is stored once in the recording medium 420. Then, after specific information is stored in the recording medium 420, the recording medium 420 is mounted on the vehicle-state collecting server 210 of the probe information center 200 and the accumulated information is read out.

In the method for charging the vehicle advertisement rate according to the embodiment, although not described in detail, transmission of the information from the advertising vehicle 100 to the probe information center 200 can be achieved by the same manner as that of the first embodiment except that, as described, the recording medium 420 is used when desired.

With the embodiment, it is possible to transmit the information on the traveling position and the traveling distance of the advertising vehicle 100 to the probe information center 200 without using the network 400 so that it enables to decrease the fee for using the network 400. The transmission of the information using the recording medium 420 is especially effective when there is a large amount and high frequency of output data from the on-vehicle terminal 120.

Some embodiments of the present invention have been described, however, these embodiments only illustrate the present invention and various modifications are possible within the scope and the spirits of the appended claims. For example, for the calculation of the advertisement rate, traveling speeds, stopping time on public roads and the like may be taken account of, in addition to the traveling unit area, traveling distance and the traveling hour of the advertising vehicle. Further, although not described in detail in each embodiment, the advertisement rate system may be set to vary according to the types of the advertising vehicles and the advertising contents.

With the present invention, it is possible to charge the vehicle advertisement rate according to the actual traveling unit area, the traveling distance, the traveling hour and the like of the advertising vehicle. Therefore, especially, the vehicle advertisement rate can be made appropriate even in the case using vehicles with no regular routes such as taxis and the like. The vehicle advertisement rate can be presented to the advertiser as a clear and detailed advertisement rate system. Thus, the advertiser can easily judge whether or not the rate is appropriate. Further, by transmitting the traveling state information of the advertising vehicle which is used for calculating the advertisement rate to be charged to the advertiser terminal, the advertiser can evaluate the appropriateness of the advertisement rate and the advertising effect by referring to the traveling state information. Thereby, it enables to improve the credibility of the advertisement rate for the advertiser.

What is claimed is:

1. A system for charging vehicle advertisement rate, comprising:
an advertisement vehicle;
information obtaining means;
calculating means; and
information sending means; wherein
the advertisement vehicle performs advertising while traveling along a street,
the information obtaining means obtains information of a traveling state that the advertisement vehicle actually travels,
the calculating means calculates advertisement rate based on advertisement rate data which has been set beforehand corresponding to traveling state information of the advertisement vehicle and on actual traveling state information of the advertisement vehicle, and
the information sending means includes the actual traveling state information of the advertisement vehicle in information of the advertisement rate calculated by the calculating means, and sends the information to an advertiser terminal.

2. The system for charging vehicle advertisement rate, as claimed in claim 1, wherein the information obtaining means obtains the traveling state information in such a manner as to include information about a place, a speed, a distance and a time of the advertisement vehicle traveling in the actual traveling state information of the advertisement vehicle.

3. The system for charging vehicle advertisement rate, as claimed in claim 1, wherein the information obtaining means is provided to the advertisement vehicle so as to obtain the actual traveling state information of the advertisement vehicle.

4. The system for charging vehicle advertisement rate, as claimed in claim 1, wherein the calculating means sets the advertisement rate data as a unit rate per unit traveling distance for each traveling area of the advertisement vehicle based on the information obtained by the information obtaining means, and stores the data.

5. The system for charging vehicle advertisement rate, as claimed in claim 4, wherein the calculating means sets the advertisement rate data while taking into account: a unit rate per unit traveling distance for each traveling area of the advertisement vehicle; and time data that the advertisement vehicle travels, based on the information obtained by the information obtaining means, and stores the advertisement rate data.

6. The system for charging vehicle advertisement rate, as claimed in claim 5, wherein the calculating means sets the advertisement rate data in such a manner as to include traveling hours and a traveling period of time that the advertisement vehicle travels in the time data, based on the information obtained by the information obtaining means, and stores the advertisement rate data.

7. A method for charging vehicle advertisement rate comprising the steps of:
advertising by an advertisement vehicle traveling along a street;
obtaining information of a traveling state that the advertisement vehicle actually travels;
calculating advertisement rate based on advertisement rate data which has been set beforehand corresponding to traveling state information of the advertisement vehicle and on an actual traveling state information of the advertisement vehicle; and
sending information to an advertiser terminal which information is so obtained as to include the actual traveling state information of the advertisement vehicle in the advertisement rate information calculated in the calculating step.

8. The method for charging vehicle advertisement rate, as claimed in claim 7, wherein the traveling state information is so obtained as to include information about a place, a speed, a distance and a time of the advertisement vehicle traveling in the actual traveling state information of the advertisement vehicle.

9. The method for charging vehicle advertisement rate, as claimed in claim 7, wherein the actual traveling state information of the advertisement vehicle is obtained through an on-vehicle terminal mounted on the advertisement vehicle.

10. The method for charging vehicle advertisement rate, as claimed in claim 7, wherein the advertisement rate data is set as a unit rate per unit traveling distance for each traveling area of the advertisement vehicle.

11. The method for charging vehicle advertisement rate, as claimed in claim 10, wherein the advertisement rate data is so set as to take into account a unit rate per unit traveling distance for each traveling area of the advertisement vehicle and time data that the advertisement vehicle travels.

12. The method for charging vehicle advertisement rate, as claimed in claim 11, wherein the advertisement rate data is so set as to include, in the time data, traveling hours and a traveling period of time that the advertisement vehicle travels.
